(19) United States
(12) Patent Application Publication
(10) Pub. No.: US 2024/0011772 A1
(43) Pub. Date: Jan. 11, 2024

(54) DIGITAL MEASURING AND DETECTION APPARATUS WITH INTERACTIVE SCREEN

(71) Applicant: ROBBOX INC., Richmond (CA)

(72) Inventor: Andrei MATEI, Coquitlam (CA)

(73) Assignee: ROBBOX INC., Richmond, BC (CA)

(21) Appl. No.: 18/348,222

(22) Filed: Jul. 6, 2023

Related U.S. Application Data
(60) Provisional application No. 63/367,796, filed on Jul. 6, 2022.

(51) Int. Cl. G01C 3/02

(52) U.S. Cl. CPC G01C 3/02

(57) ABSTRACT

An apparatus including a chassis, an interactive screen, a processor, a charging system, batteries, laser modules, an inertial sensor, sensors, and other mechanical components, which integrates the functionality of multiple modules found in various tools into one single apparatus/tool, the apparatus being separably connectable to a plurality of attachments which may expand and/or change the functionality of the apparatus depending on the attachment connected.

### CROSS-REFERENCE TO RELATED APPLICATIONS

This application claims priority to U.S. Provisional Application 63/367,796, filed Jul. 6, 2022, herein incorporated by reference.

### SUMMARY

The present disclosure describes a digital measuring and detection apparatus (herein referred to also as an “apparatus” or a “DMDA”) with an interactive screen. The DMDA may allow for the integration of multiple modules found in various tools into one single apparatus/tool. This allows users of the DMDA to perform a plurality of tasks with a single too. The DMDA may allow the user to accomplish tasks which are not possible with existing technology and tools on the market. The DMDA may reduce the time required to perform labor-intensive measuring, detection, and data transfer, reduce physical strain on users, reduce the number of tools used, save space, reduce cost, and reduce the environmental impact created by manufacturing multiple tools and batteries.

Depending on configuration, the DMDA may perform multiple tasks including, but not limited to, measuring distance with an incorporated tape measure/reel/rule and other sensors, measuring distance with a laser range finder module and other sensors, measuring distance with an optical sensor, determining level position with a accelerometer/gyroscope, detecting temperature, detecting studs, detecting humidity, detecting air quality, detecting carbon dioxide, controlling video cameras, detecting electrical elements (electrical wires), transferring data, and detecting surfaces.

The DMDA may also be docked through a mechanical/magnetic or other electromechanical system to an additional apparatus (herein referred to also as an “extension”, or “attachment”), and may detect the other external apparatus through antennas, NFC (“near field communication”), hall sensors, or other sensors or electromechanical systems. The attachment may be controlled from the DMDA via an interactive screen or touch interactive interface display. The DMDA may communicate with attachments through hard electrical wires and/or wireless communication. The DMDA may be updated with new firmware/software through hard wires and/or wireless communication.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a front isometric view of an apparatus, according to an exemplary embodiment of the present disclosure;

FIG. 2 is an exploded front isometric view of an apparatus, according to an exemplary embodiment of the present disclosure;

FIG. 3 is an exploded front isometric view of a core assembly, according to an exemplary embodiment of the present disclosure;

FIG. 4 is an exploded front isometric view of a core assembly, according to an exemplary embodiment of the present disclosure;

FIG. 5 is an exploded rear isometric view of an apparatus, according to an exemplary embodiment of the present disclosure;

FIG. 6 is an exploded rear isometric view of an apparatus, according to an exemplary embodiment of the present disclosure;

FIG. 7 is an exploded rear isometric view of a core assembly, according to an exemplary embodiment of the present disclosure;

FIG. 8A is an exploded rear isometric view of a black plate PCB, according to an exemplary embodiment of the present disclosure;

FIG. 8B is a front isometric view of an apparatus docking into an extension, according to an exemplary embodiment of the present disclosure;

FIG. 9 is a front view of an apparatus docked in an extension, according to an exemplary embodiment of the present disclosure;

FIG. 10 is a front view of an extension, according to an exemplary embodiment of the present disclosure;

FIG. 11 is a front view of an extension, according to an exemplary embodiment of the present disclosure;

FIG. 12 is a front view of an apparatus docked in a 24-in extension, according to an exemplary embodiment of the present disclosure;

FIG. 13 is a top-down isometric view of an apparatus docked in a 24-in extension, according to an exemplary embodiment of the present disclosure;

FIG. 14 is a front view of an apparatus docked in a 36-in extension, according to an exemplary embodiment of the present disclosure;

FIG. 15 is a top-down isometric view of an apparatus docked in a 36-in extension, according to an exemplary embodiment of the present disclosure;

FIG. 16A is a view of the of end caps of an extension, according to an exemplary embodiment of the present disclosure;

FIG. 16B is a view of the of end caps of an extension, according to an exemplary embodiment of the present disclosure;

FIG. 17 is a bottom view of an extension with a securing system, according to an exemplary embodiment of the present disclosure;

FIG. 18 is an isometric exploded view of an end cap of an extension, according to an exemplary embodiment of the present disclosure;

FIG. 19 is a side view of a handle area of an extension, according to an exemplary embodiment of the present disclosure;

FIG. 20 is exploded front view of a handle area of an extension, according to an exemplary embodiment of the present disclosure;

FIG. 21 is a front view of an extension docking mechanism of an extension, according to an exemplary embodiment of the present disclosure;

FIG. 22 is a side view of a laser lines attachment, according to an exemplary embodiment of the present disclosure;

FIG. 23 is an isometric front view of a laser lines attachment, according to an exemplary embodiment of the present disclosure;

FIG. 24 is a front view of an apparatus docking into a laser lines attachment, according to an exemplary embodiment of the present disclosure;

FIG. 25 is a front view of an apparatus docked in a laser line attachment, according to an exemplary embodiment of the present disclosure;

FIG. 26 is a front view of an apparatus docked in a laser line attachment, wherein the apparatus is powered on, according to an exemplary embodiment of the present disclosure;

FIG. 27 is a front view of an apparatus docked in a laser line attachment, wherein a horizontal laser line function is enabled, according to an exemplary embodiment of the present disclosure;

FIG. 28 is a front view of an apparatus docked in a laser line attachment, according to an exemplary embodiment of the present disclosure;

FIG. 29 is a front view of an apparatus docked in a laser line attachment, wherein a 360-degree laser line feature is enabled, according to an exemplary embodiment of the present disclosure;

FIG. 30 is an isometric front left view of an apparatus docked in a laser line attachment, according to an exemplary embodiment of the present disclosure;

FIG. 31 is an isometric front right view of an apparatus docked in a laser line attachment, according to an exemplary embodiment of the present disclosure;

FIG. 32 is an illustration of a first main menu screen of an apparatus, according to an exemplary embodiment of the present disclosure;

FIG. 33 is an illustration of a second main menu screen of an apparatus, according to an exemplary embodiment of the present disclosure;

FIG. 34 is an illustration of a third main menu screen of an apparatus, according to an exemplary embodiment of the present disclosure;

FIG. 35 is an illustration of a level mode screen of an apparatus, according to an exemplary embodiment of the present disclosure;

FIG. 36 is an illustration of a two-axis mode screen of an apparatus, according to an exemplary embodiment of the present disclosure;

FIG. 37 is an illustration of a measure mode of an apparatus, according to an exemplary embodiment of the present disclosure;

FIG. 38 is an illustration of a pop-up menu of an apparatus, according to an exemplary embodiment of the present disclosure;

FIG. 39 is an illustration of a find center screen of an apparatus, according to an exemplary embodiment of the present disclosure;

FIG. 40 is an illustration of a stud finder screen of an apparatus, according to an exemplary embodiment of the present disclosure;

FIG. 41 is an illustration of a stud finder screen of an apparatus, according to an exemplary embodiment of the present disclosure;

FIG. 42 in an illustration of a flashlight enabled screen of an apparatus, according to an exemplary embodiment of the present disclosure;

FIG. 43 is an illustration of a unit control screen of an apparatus, according to an exemplary embodiment of the present disclosure;

FIG. 44 is an illustration of a level mode screen of an apparatus, according to an exemplary embodiment of the present disclosure;

FIG. 45 is an illustration of a measure mode of an apparatus, according to an exemplary embodiment of the present disclosure;

FIG. 46 is an illustration of a measure mode of an apparatus, according to an exemplary embodiment of the present disclosure;

FIG. 47 is an illustration of a measure mode of an apparatus, according to an exemplary embodiment of the present disclosure;

FIG. 48 is an illustration of a level mode of an apparatus, according to an exemplary embodiment of the present disclosure;

FIG. 49 is an illustration of a measure mode of an apparatus, according to an exemplary embodiment of the present disclosure;

FIG. 50 is a front isometric illustration of an apparatus, according to an exemplary embodiment of the present disclosure;

FIG. 51 is an exploded front isometric illustration of an apparatus, according to an exemplary embodiment of the present disclosure;

FIG. 52 is an exploded front isometric illustration of an apparatus, according to an exemplary embodiment of the present disclosure;

FIG. 53 is an illustration of two laser line attachments, according to an exemplary embodiment of the present disclosure;

FIG. 54 is an illustration of an apparatus being docked in a laser lines attachment, according to an exemplary embodiment of the present disclosure;

FIG. 55 is an illustration of an apparatus docked in a laser lines attachment, wherein the apparatus is in use, according to an exemplary embodiment of the present disclosure;

FIG. 56 is an isometric illustration of an apparatus docked in an extension, according to an exemplary embodiment of the present disclosure;

FIG. 57 is an isometric illustration of an apparatus docked in an extension, according to an exemplary embodiment of the present disclosure;

FIG. 58 is a front view of an illustration of an apparatus docked in an extension, according to an exemplary embodiment of the present disclosure;

FIG. 59 is an isometric illustration of an apparatus being docked in an extension, according to an exemplary embodiment of the present disclosure;

FIG. 60 is an illustration of an apparatus docked in a laser line attachment, wherein the apparatus is in use, according to an exemplary embodiment of the present disclosure;

FIG. 61 is an illustration of an apparatus docked in an extension, wherein the apparatus is in use, according to an exemplary embodiment of the present disclosure.

### DETAILED DESCRIPTION

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). Reference throughout this document to “one embodiment”, “certain embodiments”, “an embodiment”, “an implementation”, “an example” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

According to an embodiment, the DMDA may allow for the integration of multiple modules found in various tools into one single apparatus/tool. This allows users of the DMDA to perform a plurality of tasks with a single too. The DMDA may allow the user to accomplish tasks which are not possible with existing technology and tools on the market. The DMDA may reduce the time required to perform labor-intensive measuring, detection, and data transfer, reduce physical strain on users, reduce the number of tools used, save space, reduce cost, and reduce the environmental impact created by manufacturing multiple tools and batteries.

According to an embodiment, the DMDA may perform multiple tasks including, but not limited to, measuring distance with an incorporated tape measure/reel/rule and other sensors, measuring distance with a laser range finder module and other sensors, measuring distance with an optical sensor, determining level position with a accelerometer/gyroscope, detecting temperature, detecting studs, detecting humidity, detecting air quality, detecting carbon dioxide, controlling video cameras, detecting electrical elements (electrical wires), transferring data, and detecting surfaces.

According to an embodiment, the DMDA may also be docked through a mechanical/magnetic or other electromechanical system to an additional apparatus (herein referred to also as an “extension”, or “attachment”), and can detect the other external apparatus through antennas, NFC (“near field communication”), hall sensors or other sensors or electromechanical system. The attachment may be controlled from the DMDA via an interactive screen or touch interactive interface display. The DMDA may communicate with attachments through hard electrical wires, and/or wireless communication. The DMDA may be updated with new firmware/software through hard wires or wireless communication.

According to an embodiment, the DMDA may consist of a main chassis/casing, a backplate, an interactive screen such as a touch sensitive LCD or AMOLED, a main microcontroller PCB that includes a main processor, a charging system, Li-Ion batteries, two laser range finder modules, an inertial sensor (IMU), a Bluetooth PCB, a backplate antenna with sensors, charging ports, and other electrical and mechanical components.

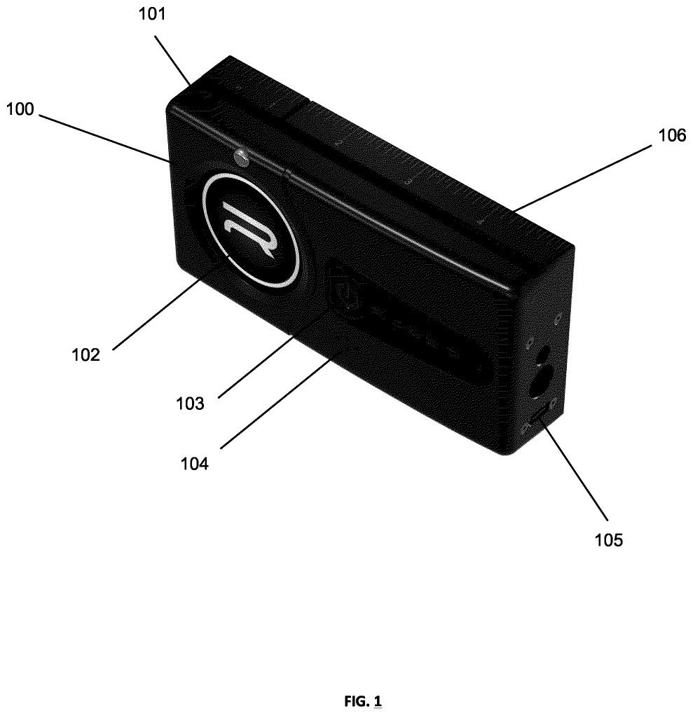

Referring now to FIG. 1, preferably the DMDA generally takes the shape of a small carriable apparatus 100 which is contained within a hard housing/chassis 101. The front face of the DMDA may comprise an interactive display 102, a power button 103, and a speaker 104. Other faces of the apparatus 100 may be patterned with a length measuring rule 106. The DMDA may have a connection port 105 for connectors such as USB-C, for the transfer of data and/or charging of the apparatus 100.

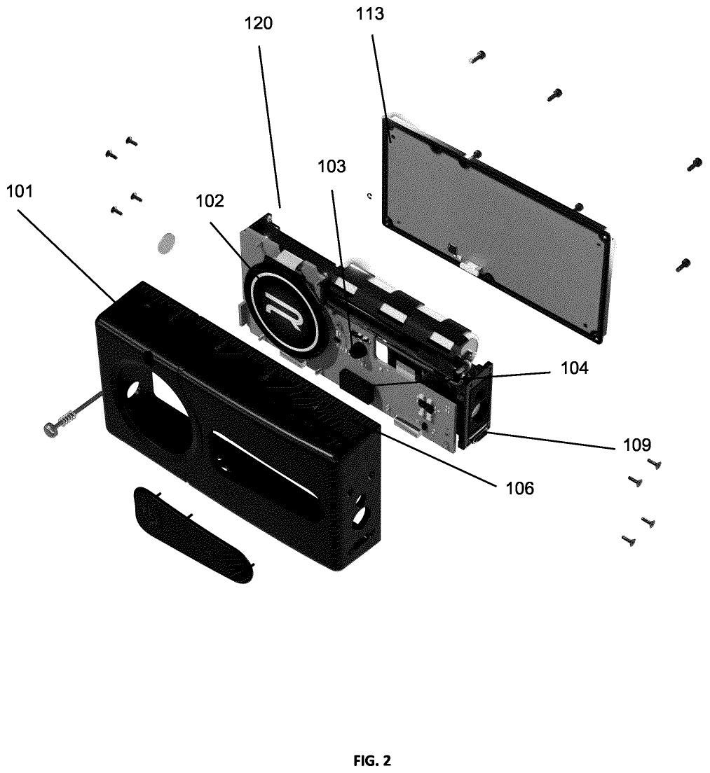

Referring now to FIG. 2, preferably the DMDA may be comprised of a functional unit 120 encased within a chassis 101 and held within the chassis 101 by a backplate 113 at the rear face of the apparatus 100. The functional unit 120 may comprise the majority of processing circuitry, memory, sensors, and input/output components of the apparatus 100. In an embodiment, the apparatus 100 may have two laser modules 109 which may function as rangefinders, preferably 40 meter rangefinders, pointers, level finders, or any combination thereof, as well as any other measuring or sensing tool which utilizes lasers.

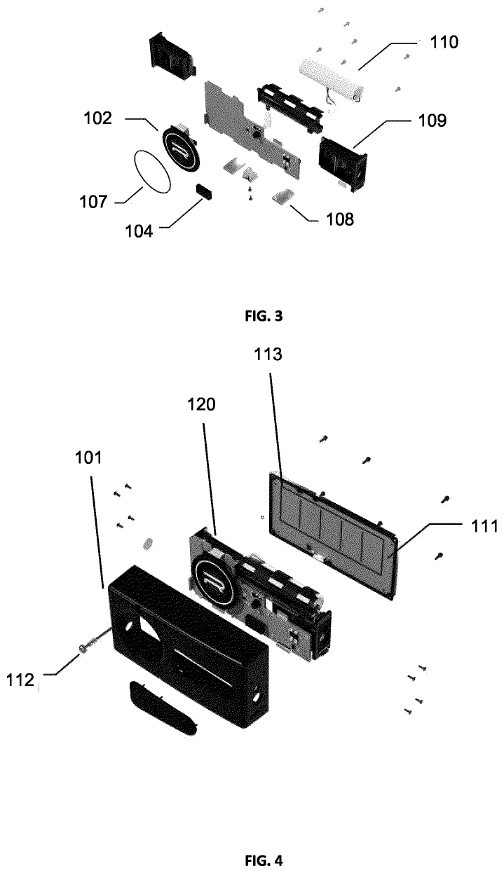

Referring now to FIG. 3, preferably the functional unit 120 may be powered by a battery 110 such as an 18650 battery cell, which may be rechargeable. Further, the interactive display 102 may be surrounded by a seal 107, such as a weatherproofing seal, to keep particulates out of the inside of the apparatus 100. Additionally, the apparatus 100 may have at least one, but preferably two, apparatus magnets 108 at the apparatus' 100 base which are configured to connect the DMDA to an attachment.

Referring now to FIG. 4, preferably the apparatus 100 may have a spring-loaded center punch 112 disposed on its front face. Further, antenna 111 may be disposed on the backplate 113, the antenna 111 being configured to connect to and communicate with attachments. Additionally, the backplate may house stud finder capacitive sensor plates which may assist in the detection of studs.

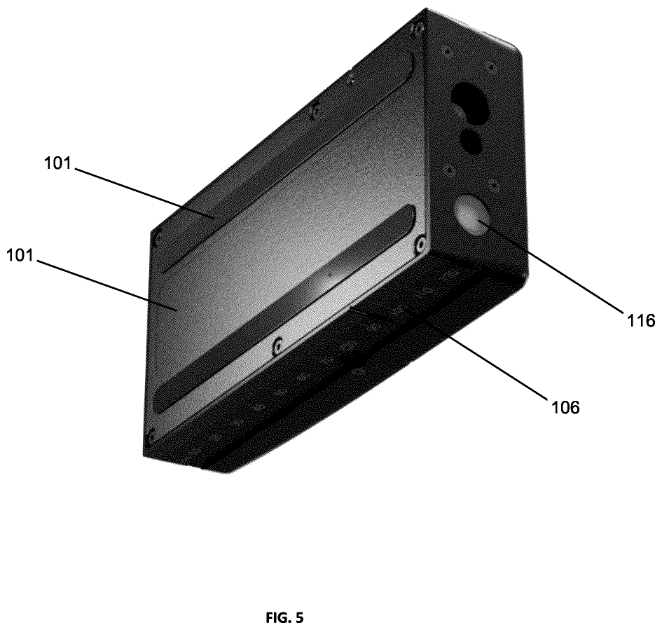

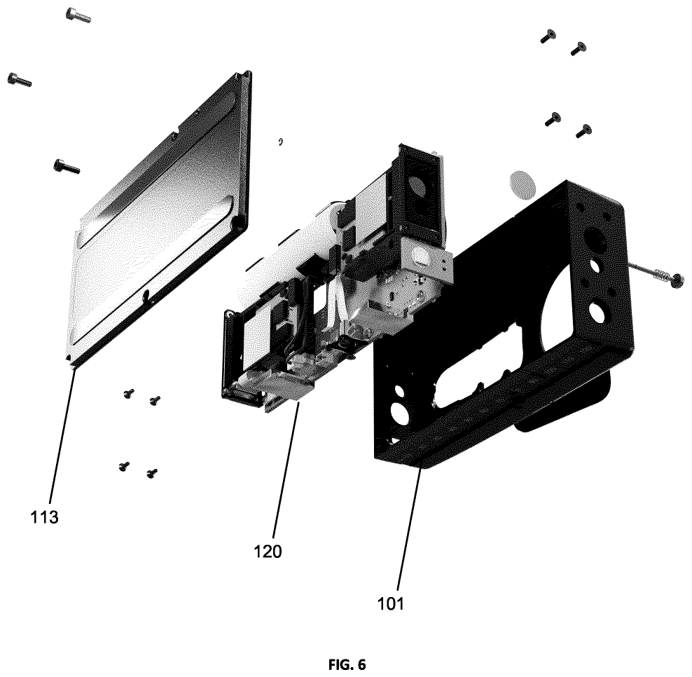

Referring now to FIG. 5, preferably the apparatus 100 may have a flashlight 116, such as an LED light, disposed on at least one face. Further, the backplate 113 may have low-friction wear strips 114 disposed on the blackplate's 113 outside surface to facilitate contact with working surfaces.

Referring now to FIG. 7, preferably the functional unit 120 is driven by a main PCB 130. In an embodiment, the battery 110 may be held in place against the functional unit 120 by a battery housing 112. Furthermore, the base of the apparatus 100 may have a mounting assembly 115 which may allow the DMDA to be separably and securely connected to attachments. Preferably the mounting assembly 115 comprises a screw and one quarter inch tripod threading.

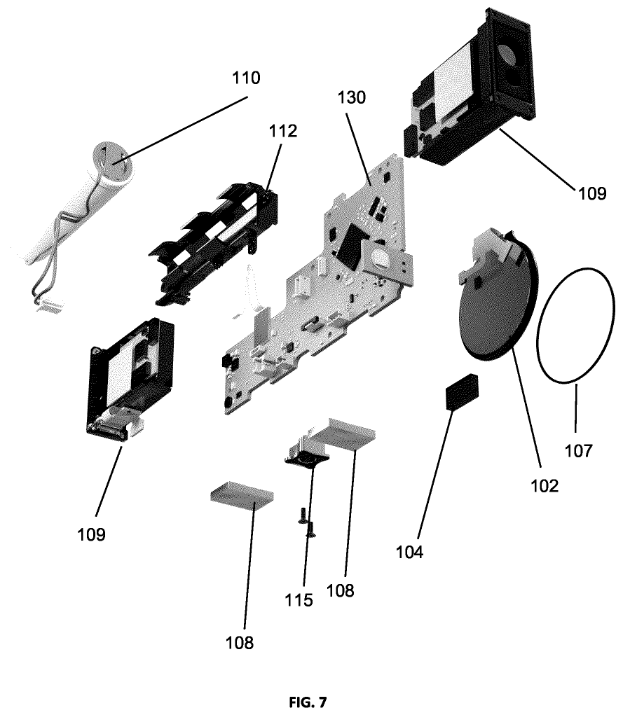

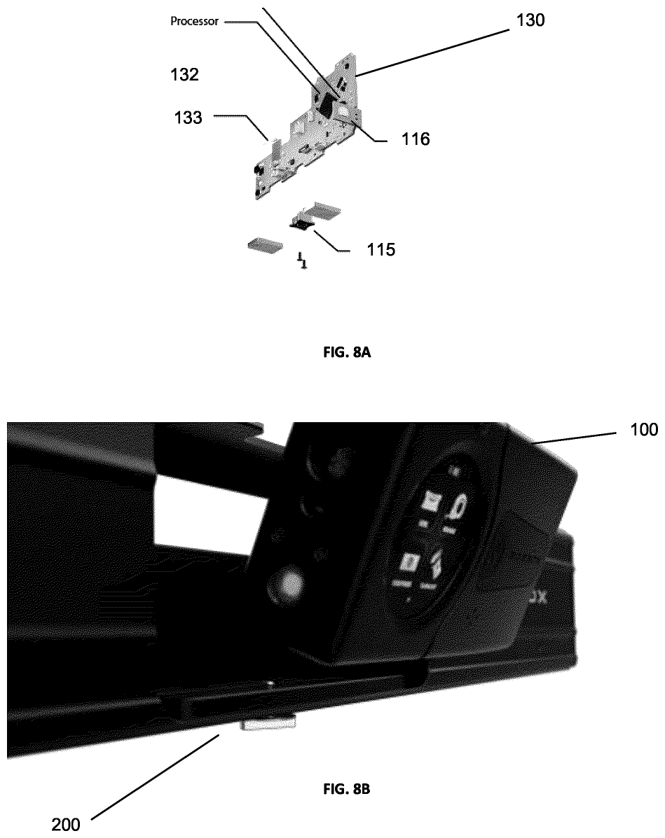

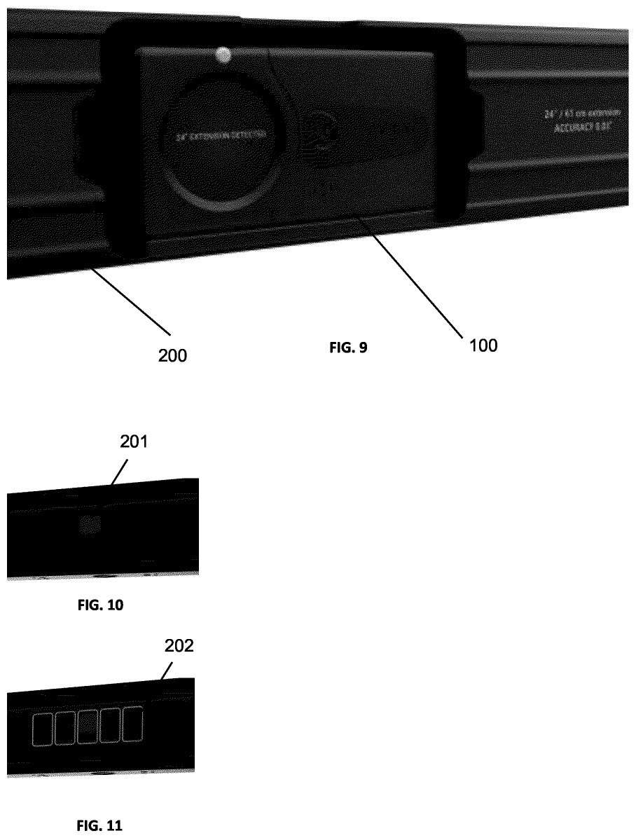

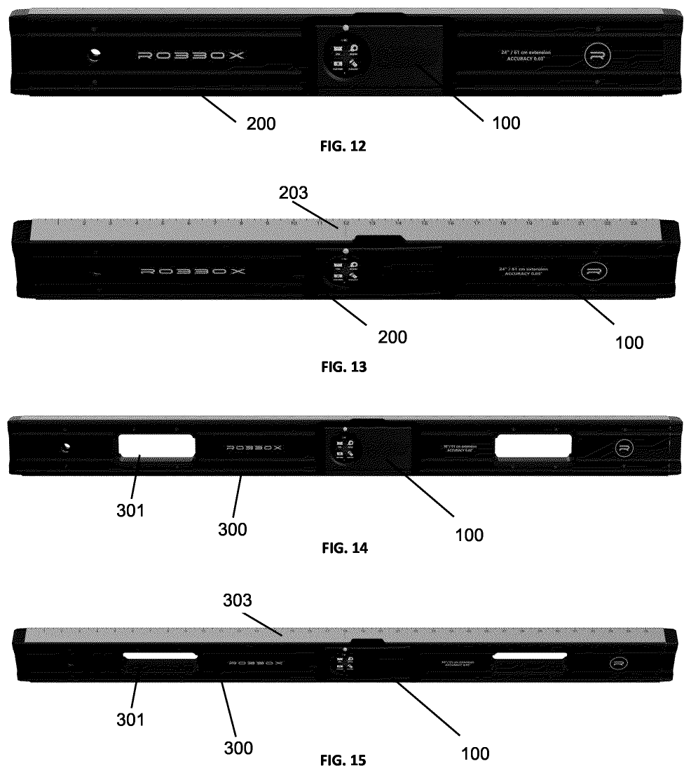

Referring now to FIG. 8A, preferably disposed on the main PCB 130, is a Bluetooth receiver/transmitter 133, a processor 132, an LED light 116, and an inertial measurement unit (IMU) 131.

Referring now to FIGS. 8B & 9-13, preferably the DMDA may be separably docked into an attachment such as a 24 in extension 200 which has a docking space 201 disposed along one face for accepting the apparatus 100. Preferably the 24 in extension 200 is 24 in in length. The 24 in extension 200 may be configured to connect to and share information with the DMDA via a series of extension antenna 202 disposed on the rear wall of the docking space 201. The docking space 201 may hold the apparatus 100 in place via magnets 108. The apparatus 100 may be further secured via the mounting assembly 115 which may allow for a screw, or similar, to be passed through the 24 in extension 200, into the apparatus 100. Preferably the extension has, disposed on at least one surface, a measuring rule 203.

Referring now to FIGS. 14-15, preferably the DMDA may also be docked into extensions similar to the 24 in extension such as a 36 in extension 300, wherein the 36 in extension 300 is 36 inches in length. These other extensions may provide similar functionality, with the 36 in extension 300 being 36 inches in length and having handles 301.

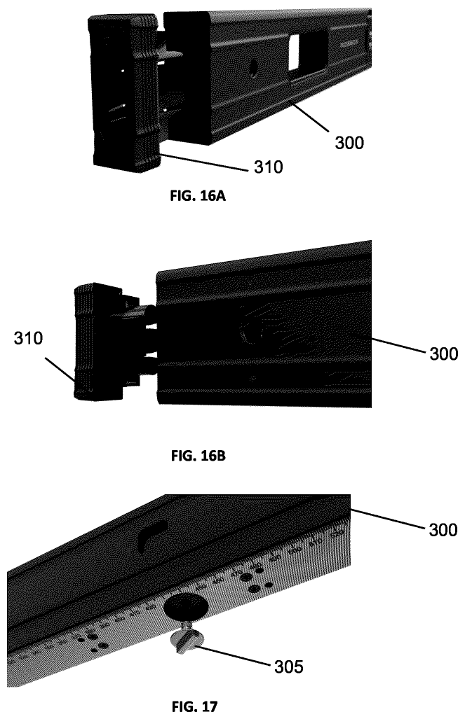

Referring now to FIGS. 16A-18, preferably the extensions 200 & 300 have endcaps 310 which may be manually attached to the ends of the extensions 200 & 300, the endcaps 310 being configured to, among other things, facilitate the passage of lasers through the endcaps 310, and assist in the measurement process. Further, the endcaps 130 are preferably affixed to the attachments via friction and/or endcap magnets 311. Additionally, in an embodiment, the mounting assembly 115 may be engaged from the bottom face of the attachment 300, by passing a screw, or the like, through both the attachment 300 and the apparatus 100.

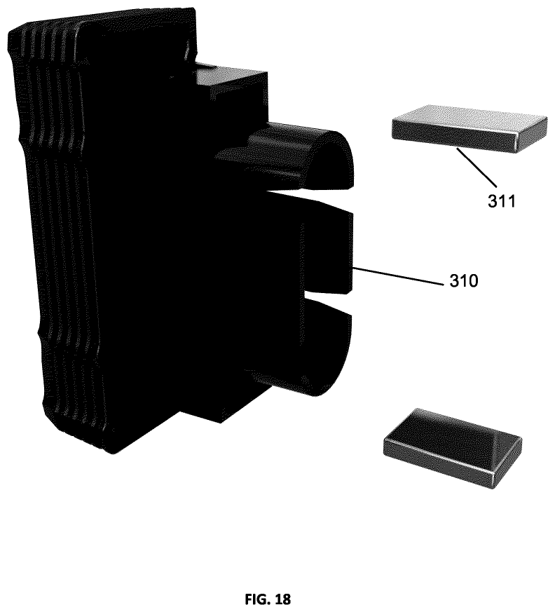

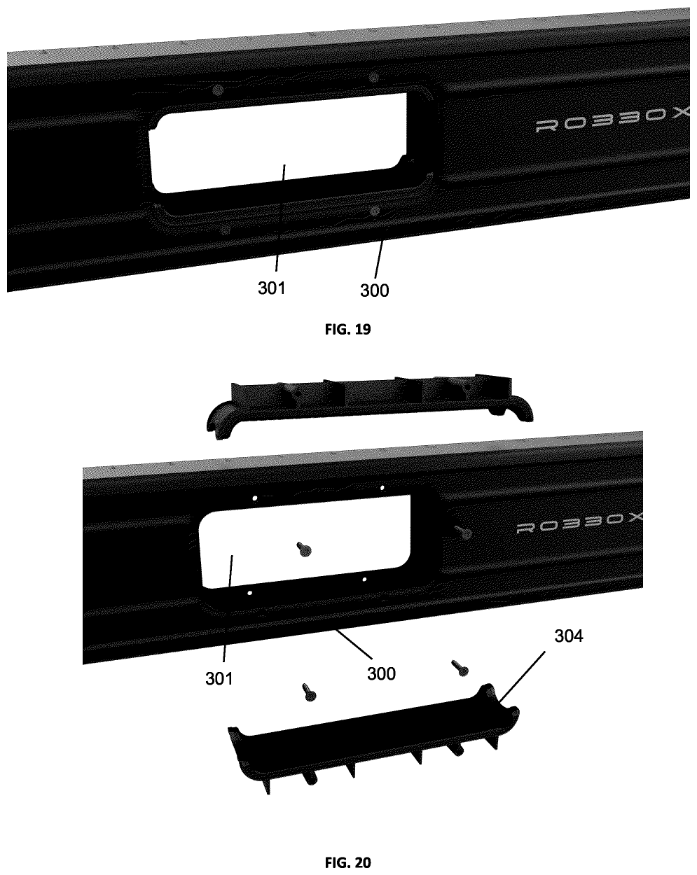

Referring now to FIGS. 19-20, preferably the handles 301 are supported by handle grips 304 disposed along the inside walls of the handles 310.

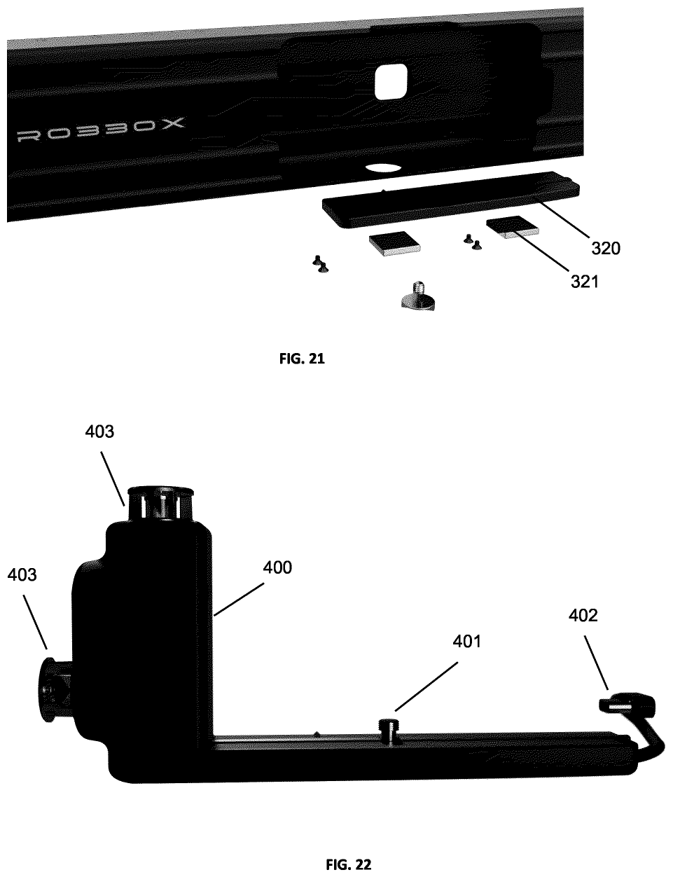

Referring now to FIG. 21, preferably the apparatus 100 may be held in place against the extension 300 by an extension plate 320. The extension plate 320 may be affixed to the extension 300 by screws and the apparatus 100 may be held against the extension plate 320 by extension magnets 321 which are of the opposite polarities from their respective apparatus magnets 108.

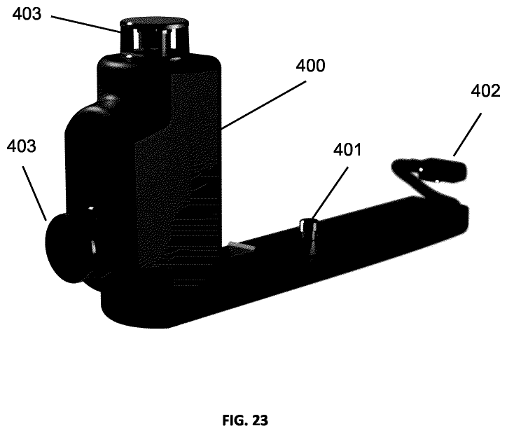

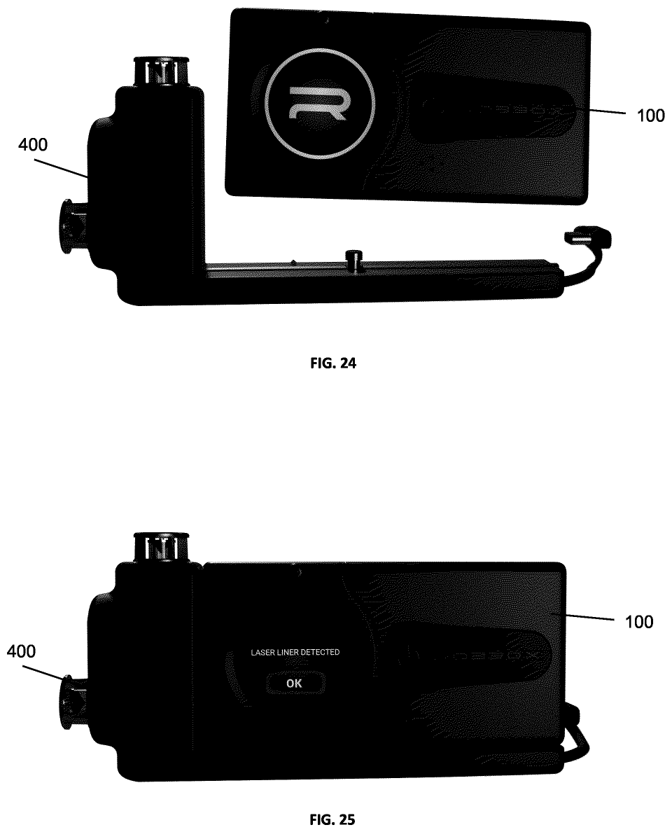

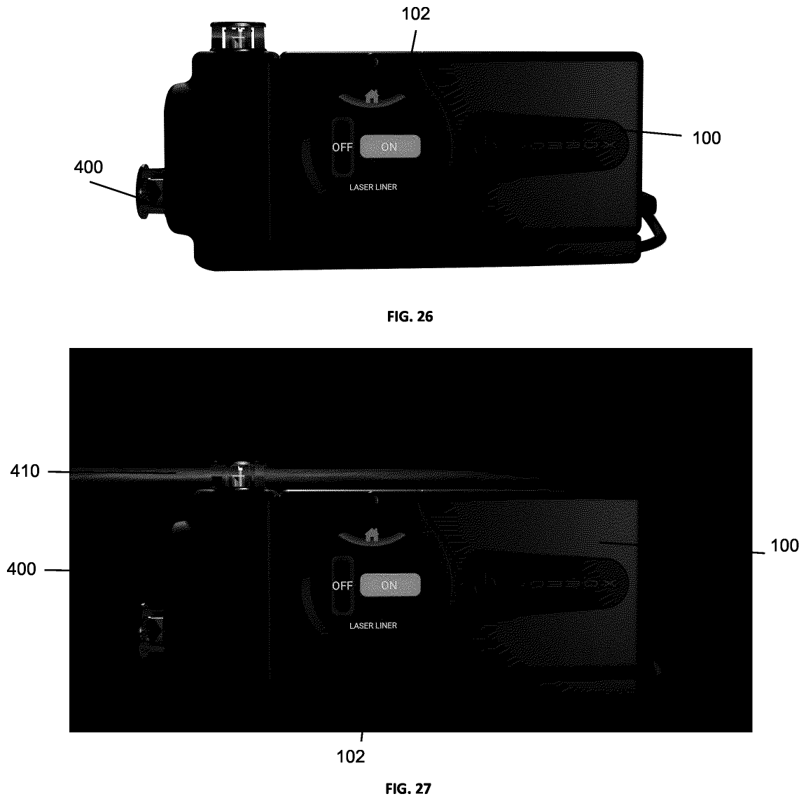

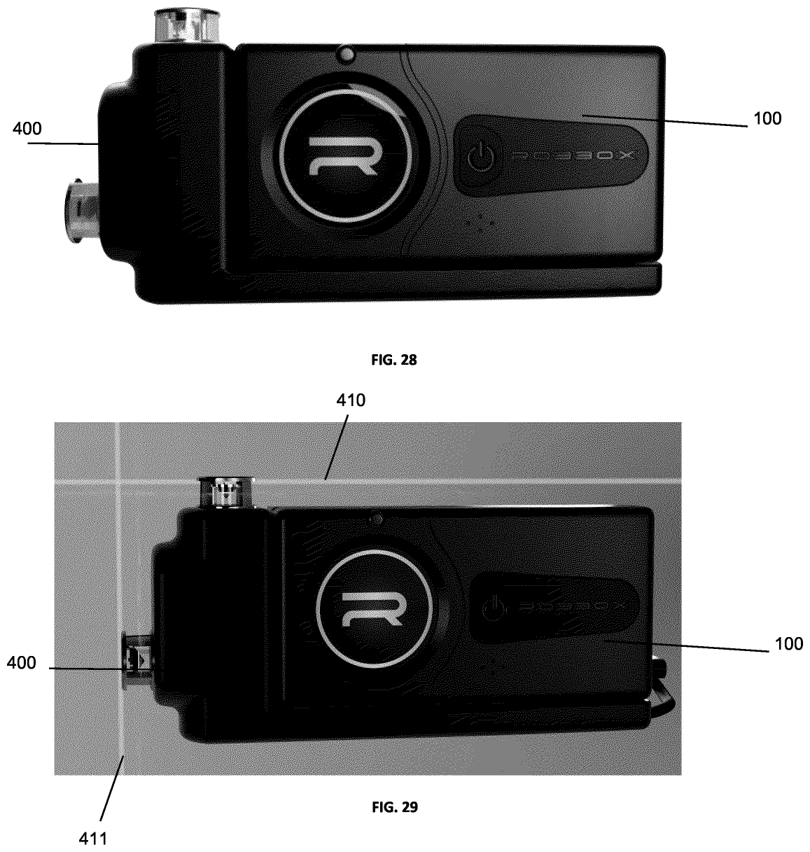

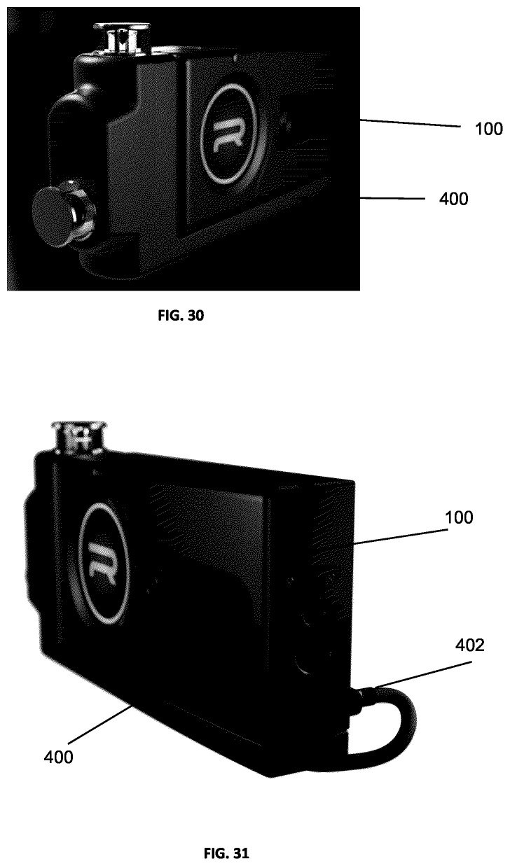

Referring now to FIGS. 22-31, the DMDA is preferably able to connect to a laser lines attachment 400 which may be configured to utilize a pair of laser beam emitters 403 to emit two lasers 403, one horizontal laser 410 and one vertical laser 411, each in 360 degrees. Preferably, each of the pair of laser beam emitters 403 are disposed on adjacent sides of the apparatus 100 and sit perpendicular to one another. Preferably the apparatus 100 may be separably affixed to the laser lines attachment 400 via a mounting point 401 such as a mounting screw which may be configured to affix to the mounting assembly 115 of the apparatus 100.

Still referring to FIGS. 22-31, preferably he DMDA may connect to the laser lines attachment 400 via a connection cable 402 disposed on the attachment, which preferably is compatible with the connection port 105 on the apparatus.

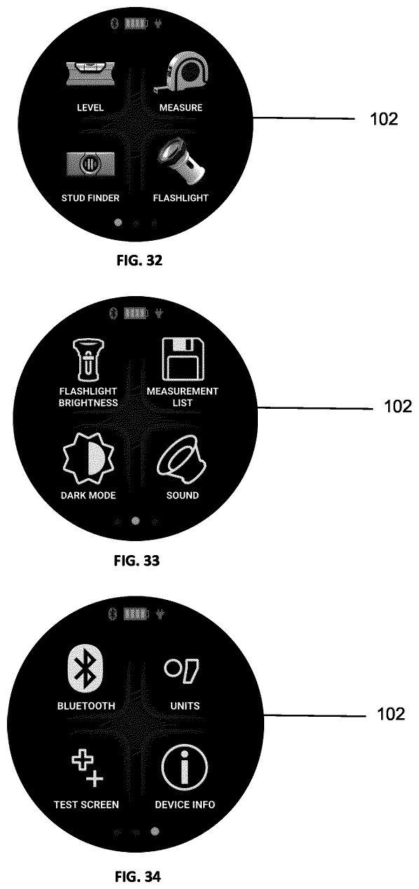

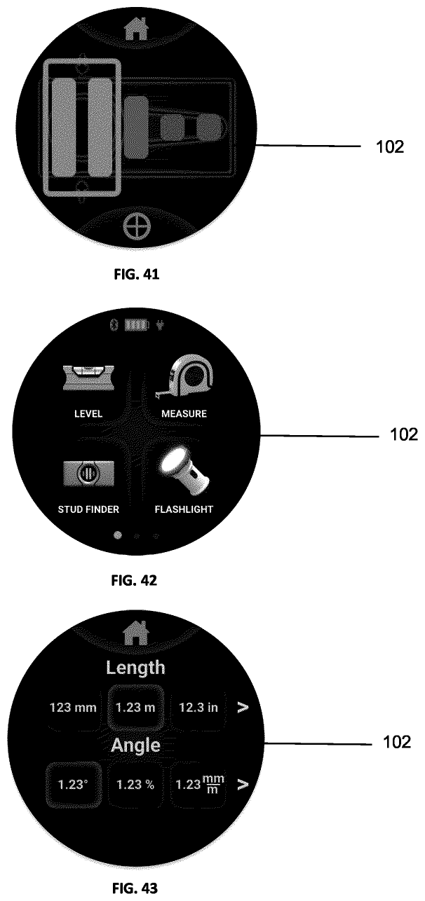

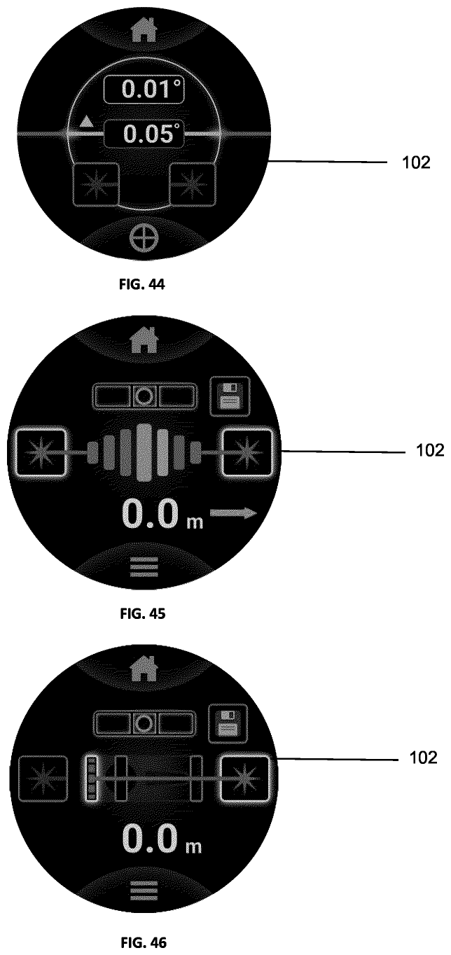

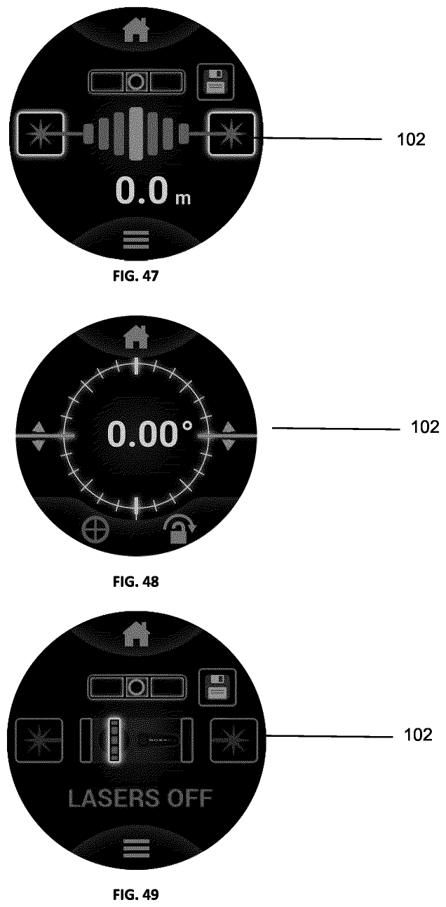

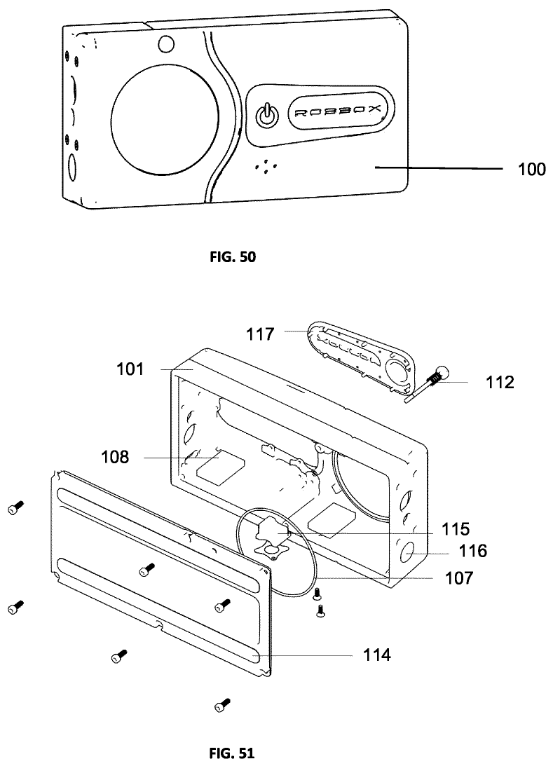

Referring now to FIGS. 32-49, preferably the interactive screen 102 may be used to interact with the apparatus 100. The DMDA may store a plurality of screens with graphics and custom controls into the memory of the microcontroller PCB. The applications installed may be relevant to the sensors that are incorporated into the apparatus. New applications may be installed onto the apparatus, with different graphics and controls, as new solutions or applications are found and/or developed. Further, additional sensors may be added to/integrated into the apparatus and new files with graphics and controls may be added via firmware updates. The firmware updates may be performed via wireless communication or via hard wire. Exemplary graphics and controls are shown in FIGS. 22-49, but the screens and functionality of the apparatus are not limited to the present disclosure.

Still referring to FIGS. 32-49, amongst other functionality, the DMDA may have Bluetooth support, a battery status display, a charging state display, a digital level, a laser measurer, a stud finder, a flashlight, a flashlight brightness control, a measurement list, a dark mode, sound controls, Bluetooth controls, unit controls/memory, a test screen, and an apparatus info screen.

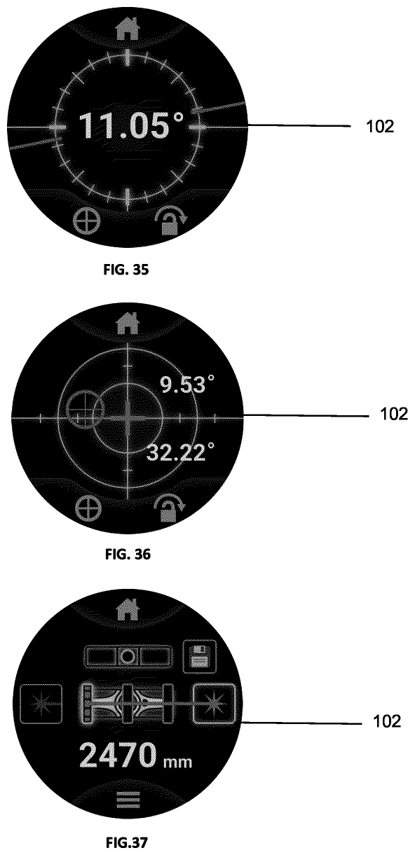

Referring now to FIG. 35, preferably, the level measuring system allows for axis position to be frozen or locked and units to be changed by swiping side to side. Flipping the apparatus 90 degrees may cause the apparatus to switch to a different one-axis or two-axis mode. The two-axis mode may display the relationship of both measured axis simultaneously via the circle seen in FIG. 36.

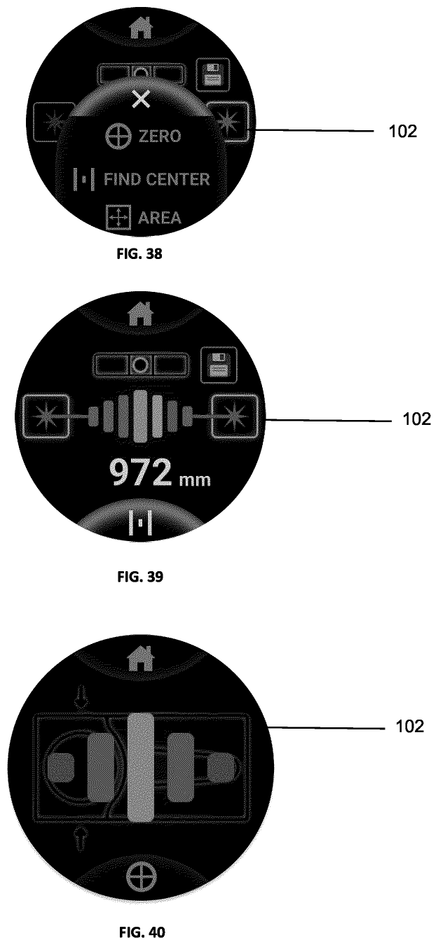

Referring now to FIGS. 37 and 38, preferably the measure mode allows for the use of both laser measuring modules alongside the digital level, and the distance measure offset may be changed via the interactive display 102. Preferably each laser module 109 supports multiple modes: left, right, and center offset. The lasers may also be turned off and on by touching the star button and the green dot may indicate the level position. The save/floppy disc button may record measurements upon being pressed. Preferably swiping up will allow for other tools to be accessed such as a zero mode allowing reference points to be set, a find center mode which will continuously calculate the center between the two laser measurements at a refresh rate that may be 8 HZ, and an area mode which may measure two dimensions with one or two lasers to calculate surface area. In an embodiment, one or more of the laser modules 109 may be disabled while using the measure mode which may prompt the interactive display to indicate that the lasers are off or disabled.

Referring now to FIG. 51, preferably the apparatus 100 has a waterproof front panel 117 which may be affixed to the front surface of the chassis 101.

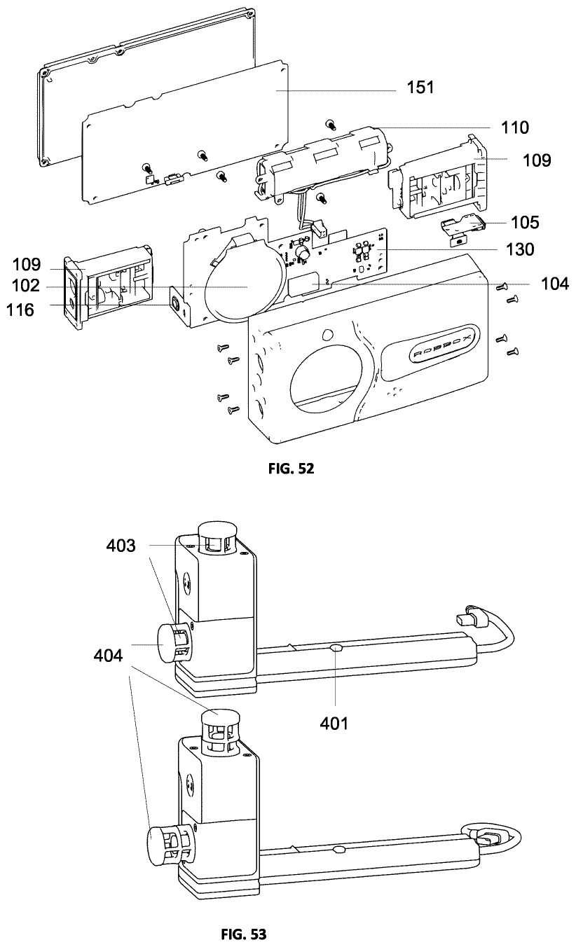

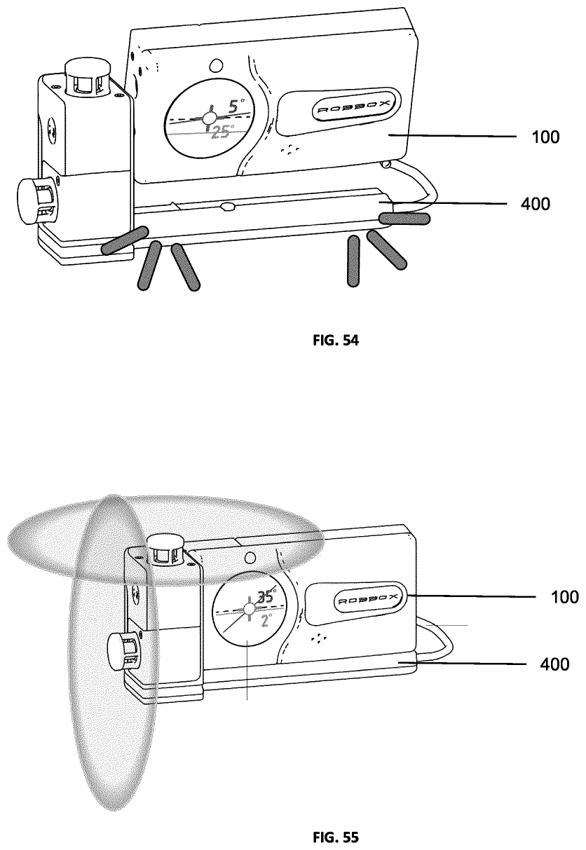

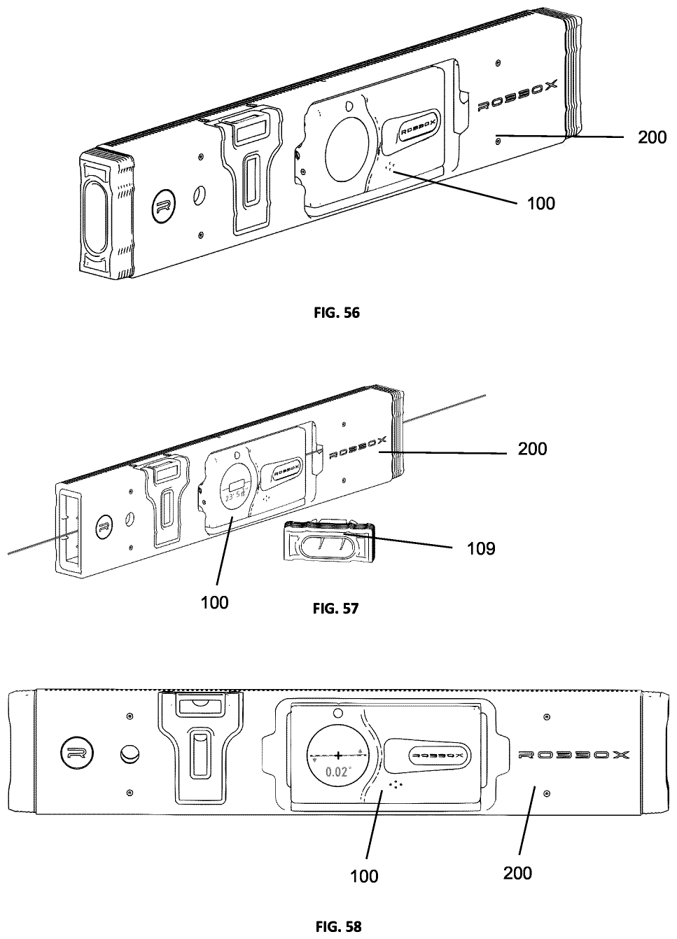

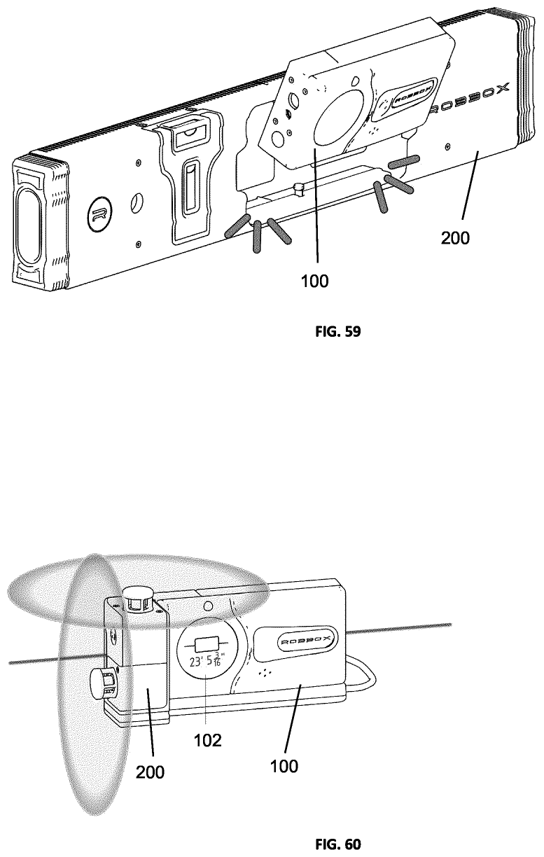

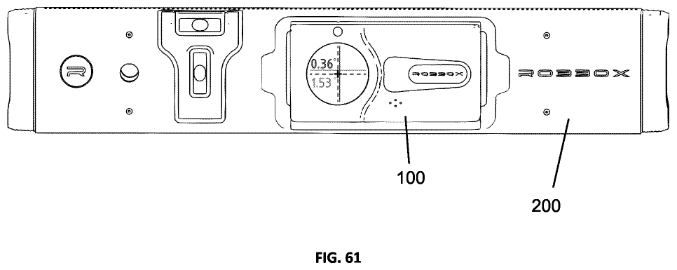

Referring now to FIG. 53, preferably the laser lines attachment 400 has a plurality of either full 360 degree or blocked 180 degree switchable caps which may variably obstruct the laser paths of the horizontal 410 and vertical 411 lasers emitted from the laser beam emitters 403.

According to an embodiment, the DMDA may include a CPU or PCB which may perform some portions of, or the entirety of, the processes described herein. The process data and instructions may be stored in apparatus memory. These processes and instructions may also be stored on a storage medium disk such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk, or any other information processing apparatus with which the apparatus may communicate, such as a server or computer. Further, the claimed advancements may be provided as a utility application, background daemon, or component of an operating system, or combination thereof, executing in conjunction with CPU and an operating system such as Microsoft Windows 11, UNIX, Solaris, LINUX, Apple MAC-OS and other systems known to those skilled in the art.

The hardware elements used to achieve the apparatus may be realized by various circuitry elements known to those skilled in the art. For example, the CPU may be a specially programmed Xenon or Core processor from Intel of America or an Opteron processor from AMD of America or may be any other processor type that would be recognized by one of ordinary skill in the art. Alternatively, the CPU may be implemented on an FPGA, ASIC, PLD or discrete logic circuits, as one of ordinary skill in the art would recognize. Further, the CPU may be implemented as multiple processors cooperatively working in parallel to perform the instructions of the inventive processes described above.

The apparatus also may include a network controller, such as an Intel Ethernet PRO network interface card from Intel Corporation of America, for interfacing with a network. As can be appreciated, the network may be a public network, such as the Internet, or a private network such as an LAN or WAN network, or any combination thereof, and may also include PSTN or ISDN sub-networks. The network may also be wired, such as an Ethernet network, or may be wireless such as a cellular network including EDGE, 3G, 4G, and 5G wireless cellular systems. The wireless network may also be WiFi, Bluetooth, or any other wireless form of communication that is known.

The apparatus may further a display controller, such as a NVIDIA GeForce GTX or Quadro graphics adaptor from NVIDIA Corporation of America for interfacing with a display, such as a Hewlett Packard HPL2445w LCD monitor. In an embodiment, the display is a flexible OLED touch screen. A general purpose I/O interface may interface the touch screen on or separate from the display.

A sound controller may also be provided in the apparatus, such as Sound Blaster X-Fi Titanium from Creative, to interface with speakers and/or a microphone, thereby providing sounds and/or music. In an embodiment, the speakers and/or microphone may allow for voice control of the apparatus and provide notifications to the user of pertinent events.

A laser finder controller may also be provided in the apparatus to interface with laser apertures comprising laser emitting diodes and laser receivers. In an embodiment, the laser finder controller is configured to control the operation of a laser emitting diode and laser receiver.

A haptic controller may also be provided in the apparatus to interface with a haptic motor. The haptic motor may be provided within the apparatus and may be configured to provide a vibratory alert to the user of the apparatus under specific situations. The general-purpose storage controller may connect the storage medium disk with a communication bus, which may be an ISA, EISA, VESA, PCI, or similar, for interconnecting all of the components of the apparatus. A description of the general features and functionality of the display as well as the display controller, storage controller, network controller, sound controller, laser finder controller, haptic controller, and general purpose I/O interface is omitted herein for brevity.

According to an embodiment, the DMDA may be outfitted with a variety of sensors and measurement devices that may be customized for a specific application. The DDCM may incorporate sensors such as laser(s), accelerometer(s), magnetometer(s), gyroscope(s), RFID tag(s)/reader(s), camera(s), stud finder(s), microphone(s), temperature sensor(s), pressure sensor(s), humidity sensor(s), carbon dioxide and/or carbon monoxide sensor(s) (or other gas sensor(s)), Global Positioning System (GPS) receiver(s), microphone(s), multimeter(s), magnetic sensor(s), and other electronic sensors.

According to an embodiment, the DMDA may provide feedback to a user during operation or use in a variety of forms. To this end, the DMDA may incorporate a variety of feedback devices including screen(s), display(s), speaker(s), haptic apparatus(s), buzzer(s), alarm(s), light(s) such as light emitting diodes (LEDs), and the like. The display(s) and other feedback devices can provide the user with feedback in the form of notifications, messages, a heads up display (HUD), icons, measurements, graphs, images, video, data, updates, settings, configuration, alerts, warnings, indications, and the like.

According to an embodiment, a user may interact with the DMDA using a variety of methods including touch control (capacitive, resistive, and the like), buttons, sliders, dials, rotating bezels, switches, voice control, motion gestures, movement of the apparatus, location of the DMDA, and the like.

Obviously, numerous modifications and variations are possible in light of the above teachings. It is therefore to be understood that within the scope of the appended claims, the invention may be practiced otherwise than as specifically described herein.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. An apparatus, comprising:
an interactive screen;
a chassis;
an antenna;
a laser distance module; and
processing circuitry configured to:
receive, from the laser distance module, laser distance data;
receive, from the antenna, connected extension data;
calculate, from the laser distance data and the connected extension data, a distance reading; and
update the interactive screen to display the distance reading.
